(19) United States
(12) Patent Application Publication
(10) Pub. No.: US 2014/0169133 A1
(43) Pub. Date: Jun. 19, 2014

(54) MEMORY-BOUND SURFACE-RELATED MULTIPLE PREDICTION METHOD FOR LARGE DATASETS

(71) Applicants: Tamas Nemeth, San Ramon, CA (US); Peeter Akerberg, Walnut Creek, CA (US); Oliver Pell, London (GB); Oskar Mencer, London (GB)

(72) Inventors: Tamas Nemeth, San Ramon, CA (US); Peeter Akerberg, Walnut Creek, CA (US); Oliver Pell, London (GB); Oskar Mencer, London (GB)

(73) Assignee: Chevron U.S.A. Inc., San Ramon, CA (US)

(21) Appl. No.: 13/713,080

(22) Filed: Dec. 13, 2012

(51) Int. Cl. G01V 1/28; G01V 1/36

(52) U.S. Cl. CPC G01V 1/28; G01V 1/364
USPC 367/43; 367/52

(57) ABSTRACT

A method is performed at a FPGA coprocessor having memory that stores a plurality of blocks of compressed seismic traces. The method includes: receiving, from a host, a request for processing a predefined set of seismic traces, the request including block location and trace header information; accessing one or more of the blocks of compressed seismic traces from the memory in accordance with the block location information; decompressing each of the one or more accessed blocks into one or more seismic traces thereby forming a plurality of decompressed traces of seismic data; selecting all or a portion of the decompressed traces of seismic data in accordance with the trace header information; processing the selected decompressed traces of seismic data by applying one or more predefined operations to the seismic data; and returning the processed seismic data to the host.

### TECHNICAL FIELD

The disclosed implementations relate generally to seismic data processing, and in particular, to system and method for performing one or more operations to seismic data at a field-programmable gate array.

### BACKGROUND

A field-programmable gate array (FPGA) is an integrated circuit that can be incorporated into a CPU-based host environment as a coprocessor using PCI Express, InfiniBand or other connections. Currently, there are FPGA coprocessors with 24 or even 48 gigabytes of memory on the market developed for applications such as high-performance computing. The massive amount of memory within an FPGA coprocessor makes the resulting coprocessor a good candidate both as a device for computational speed-up of seismic data processing applications and/or for fast data storage.

### SUMMARY

In accordance with some implementations described below, a seismic data processing method is performed at an FPGA coprocessor having memory that stores a plurality of blocks of compressed seismic traces. The method includes: receiving, from a host, a request for processing a predefined set of seismic traces, the request including block location information and trace header information; identifying one or more of the plurality of blocks of compressed seismic traces in the memory in accordance with the block location information; decompressing each of the one or more identified blocks to retrieve one or more seismic traces thereby forming a plurality of decompressed traces of seismic data; selecting all or a portion of the plurality of decompressed traces of seismic data in accordance with the trace header information; processing all or the portion of the plurality of decompressed traces of seismic data by applying one or more predefined operations to the seismic data; and returning the processed seismic data to the host.

In some implementations, the predefined set of seismic traces is used for predicting surface-related multiples within a seismic trace between a source and a receiver. For example, the predefined set of seismic traces is collected within a region defined by the source and the receiver. The host is configured to generate a seismic trace between the source and the receiver that is substantially free of surface-related multiples by subtracting the processed seismic data from the seismic trace between the source and the receiver.

In some implementations, the one or more predefined operations include applying a normal moveout to a decompressed trace of seismic data, performing a fast Fourier transform (FFT) to a decompressed trace of seismic data, convolving a respective pair of decompressed traces of seismic data when the trace information corresponding to the respective pair of decompressed traces satisfies a predefined condition, and stacking a plurality of decompressed traces of seismic data. In some instances, the predefined condition for convolving the respective pair of decompressed traces of seismic data is that the source or receiver locations of the two decompressed traces of seismic data correspond to one downward reflection point such that a convolution of the two decompressed traces of seismic data generates a prediction of surface-related multiples associated with the downward reflection point. In some cases, the respective pair of decompressed traces of seismic data is retrieved from the same block of compressed seismic traces. In some other cases, the respective pair of decompressed traces of seismic data is retrieved from two distinct blocks of compressed seismic traces.

In some implementations, different blocks of compressed seismic traces are decompressed using different sets of decompression parameters, which are included in the request from the host to the FPGA coprocessor.

In some implementations, each block of compressed seismic traces includes a plurality of traces of seismic data whose associated mid-point coordinates are within a predefined two-dimensional area on the surface of the earth.

In accordance with some implementations described below, a seismic data processing method is performed by a host and a FPGA coprocessor. The host determines location information of a plurality of pairs of seismic traces for a target seismic trace, the plurality of pairs of seismic traces being used for predicting coherent noise in the target seismic trace. The host then sends the location information of the plurality of pairs of seismic traces to the FPGA coprocessor whose memory stores a plurality of blocks of compressed seismic traces. The FPGA coprocessor accesses blocks of compressed seismic traces in the plurality of blocks in the memory in accordance with the location information of the plurality of pairs of seismic traces, decompresses the identified blocks of compressed seismic traces and retrieves the plurality of pairs of seismic traces from the decompressed blocks of seismic traces. The FPGA coprocessor applies one or more predefined operations to the retrieved plurality of pairs of seismic traces to generate an estimate of the coherent noise in the target seismic trace and returns the estimate of the coherent noise from the FPGA coprocessor to the host. Finally, the host subtracts the estimate of the coherent noise from the target seismic trace.

In some implementations, the coherent noise is surface-related multiples.

In some implementations, the location information of each pair of seismic traces identifies respective locations of two source-receiver pairs associated with the two seismic traces and the respective locations of the two source-receiver pairs correspond to three locations on the surface of the earth including respective locations of a source-receiver pair associated with the target seismic trace and a location of a downward reflection point between the source-receiver pair.

In some implementations, the one or more predefined operations include applying a normal moveout to a decompressed trace of seismic data, performing a FFT to a decompressed trace of seismic data, convolving a respective pair of decompressed traces of seismic data when the trace information corresponding to the respective pair of decompressed traces satisfies a predefined condition, and stacking a plurality of decompressed traces of seismic data.

In some implementations, the predefined condition for convolving the respective pair of decompressed traces of seismic data is that the source or receiver locations of the two decompressed traces of seismic data correspond to one downward reflection point such that a convolution of the two decompressed traces of seismic data generates a prediction of surface-related multiples associated with the downward reflection point.

In some implementations, the respective pair of decompressed traces of seismic data are retrieved from the same block of compressed seismic traces.

In accordance with some implementations described below, an FPGA coprocessor configured for seismic data processing includes memory, wherein there are a plurality of blocks of compressed seismic traces in the memory; and seismic data processing logic. The seismic data processing logic is configured to receive, from a host, a request for processing a predefined set of seismic traces, the request including block location information and trace header information. The seismic data processing logic is further configured to access one or more of the plurality of blocks of compressed seismic traces from the memory in accordance with the block location information. The seismic data processing logic is further configured to decompress each of the one or more accessed blocks into one or more seismic traces thereby forming a plurality of decompressed traces of seismic data. The seismic data processing logic is further configured to select all or a portion of the plurality of decompressed traces of seismic data in accordance with the trace header information. The seismic data processing logic is further configured to process all or the portion of the plurality of decompressed traces of seismic data by applying one or more predefined operations to the seismic data and return the processed seismic data to the host.

In some implementations, the predefined set of seismic traces is used for predicting surface-related multiples within a seismic trace between a source and a receiver.

In some implementations, the one or more predefined operations include applying a normal moveout to a decompressed trace of seismic data, performing a FFT to a decompressed trace of seismic data, convolving a respective pair of decompressed traces of seismic data when the trace information corresponding to the respective pair of decompressed traces satisfies a predefined condition, and stacking a plurality of decompressed traces of seismic data.

Another embodiment provides a method. The method comprises determining, at a host, location information of a plurality of pairs of seismic traces for a target seismic trace, where the plurality of pairs of seismic traces are used for predicting coherent noise in the target seismic trace. The location information of the plurality of pairs of seismic traces is sent from the host to an FPGA coprocessor. There is a plurality of blocks of compressed seismic traces in a memory of the FPGA coprocessor. At the FPGA coprocessor, blocks of compressed seismic traces in the plurality of blocks in the memory are accessed in accordance with the location information of the plurality of pairs of seismic traces. At the FPGA coprocessor, the accessed blocks of compressed seismic traces are decompressed and the plurality of pairs of seismic traces is retrieved from the decompressed blocks of seismic traces. At the FPGA coprocessor, one or more predefined operations are applied to the retrieved plurality of pairs of seismic traces to generate a result. The result is returned from the FPGA coprocessor to the host. The result is further processed by the host for a target seismic trace. In some embodiments, the result is an estimate of the coherent noise from the FPGA coprocessor to the host and the and the further processing comprises subtracting the estimate of the coherent noise from the target seismic trace.

### BRIEF DESCRIPTION OF DRAWINGS

The aforementioned implementation of the invention as well as additional implementations will be more clearly understood as a result of the following detailed description of the various aspects of the invention when taken in conjunction with the drawings. Like reference numerals refer to corresponding parts throughout the several views of the drawings.

FIG. 1 is a block diagram illustrating how surface-related multiples are generated in a typical marine seismic data collection setting.

FIGS. 2A and 2B are block diagrams illustrating how surface-related multiples are predicted using primary-only seismic traces.

FIGS. 3A to 3D are block diagrams illustrating how surface-related multiples are predicted using 3-D seismic traces.

FIGS. 4A to 4C are block diagrams illustrating an FPGA-based architecture for processing seismic data in accordance with some implementations.

FIGS. 5A and 5B are flow charts illustrating how a host interacts with an FPGA coprocessor for performing predefined operations to a seismic dataset stored in the memory of the FPGA coprocessor in accordance with some implementations.

### DETAILED DESCRIPTION

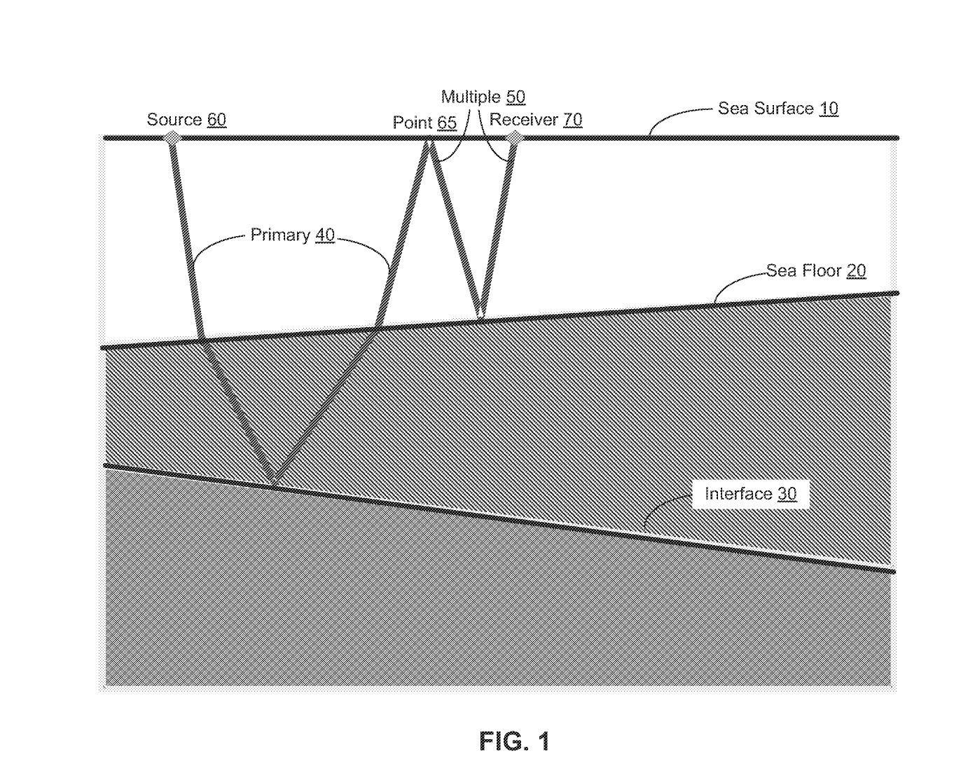

FIG. 1 is a block diagram illustrating how surface-related multiples are generated in a typical marine seismic data collection setting. In this simplified geological model, there is a sea surface 10, a sea floor 20, and a geological interface 30 in subterranean earth. A source 60/receiver 70 pair is deployed on the sea surface 10 for collecting a trace of seismic data. As shown in the figure, a seismic wave from the source 60 propagates downward into the underground earth and a portion of the seismic wave is reflected by the interface 30 and reaches the sea surface 10 at the point 65. This portion of the seismic wave, when collected by a receiver at the point 65, is referred to as “primary 40.” Because of the significant difference in density between the sea water and the air, part of the seismic wave reaching the sea surface 10 at the point 65 is bounced back into the sea water and then reflected by the sea floor 20 and finally captured by the receiver 70, thereby forming a surface-related multiple in the seismic trace generated by the receiver 70.

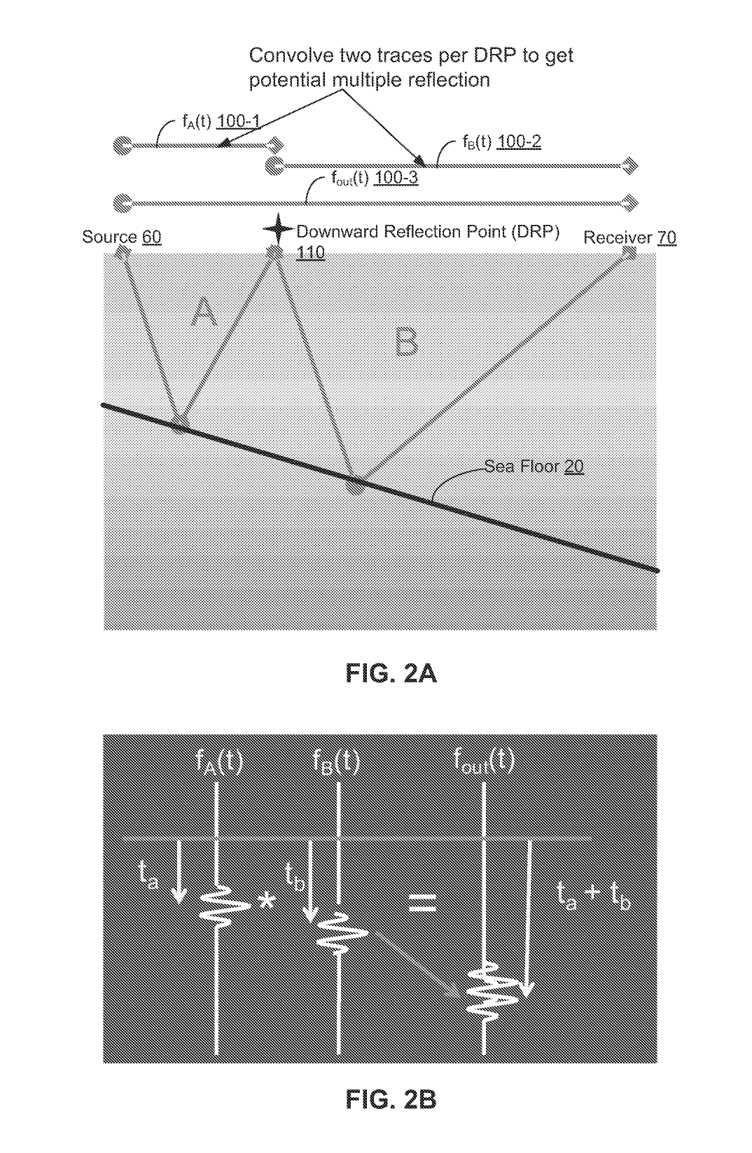

Surface-related multiples are an import type of coherent noise in marine seismic data, which adversely affects the imaging result from the seismic data. Many approaches have been developed to eliminate or at least attenuate surface-related multiples from the marine seismic data, one of which is to use the primaries in the seismic data to predict the surface-related multiples and then subtract the predicted multiples from the seismic data that includes both primaries and multiples. FIGS. 2A and 2B are block diagrams illustrating how surface-related multiples are predicted using primary-only seismic traces. As shown in FIG. 2A, the surface-related multiple between the source 60 and the receiver 70 can be divided into two primaries, a first primary between the source 60 and the downward reflection point (DRP) 110 (assuming that there is a receiver at the DRP 110) and a second primary between the DRP 110 (assuming that there is a source at the DRP 110) and the receiver 70. In other words, given a seismic trace f_{A}(t) 100-1 associated with the pair of source 60 and DRP 110 and a seismic trace f_{B}(t) 100-2 associated with the pair of DRP 110 and receiver 70, a seismic trace fₒᵤₜ(t) 100-3 including the surface-related multiple between the source 60 and the receiver 70 can be generated by convolving the two seismic traces as follows:

fₒᵤₜ(t)=f_{A}(t)*f_{B}(t),

wherein the symbol ‘*’ stands for a convolution operation. FIG. 2B illustrates that the effect of convolving the seismic trace f_{A}(t) with the seismic trace f_{B}(t) is to add the time delay tₐ associated with the primary in the seismic trace f_{A}(t) and the time delay t_{b} associated with the primary in the seismic trace f_{B}(t) to predict the time delay (tₐ+t_{b}) of the event in the seismic trace fₒᵤₜ(t) that corresponds to the surface-related multiple shown in FIG. 2A.

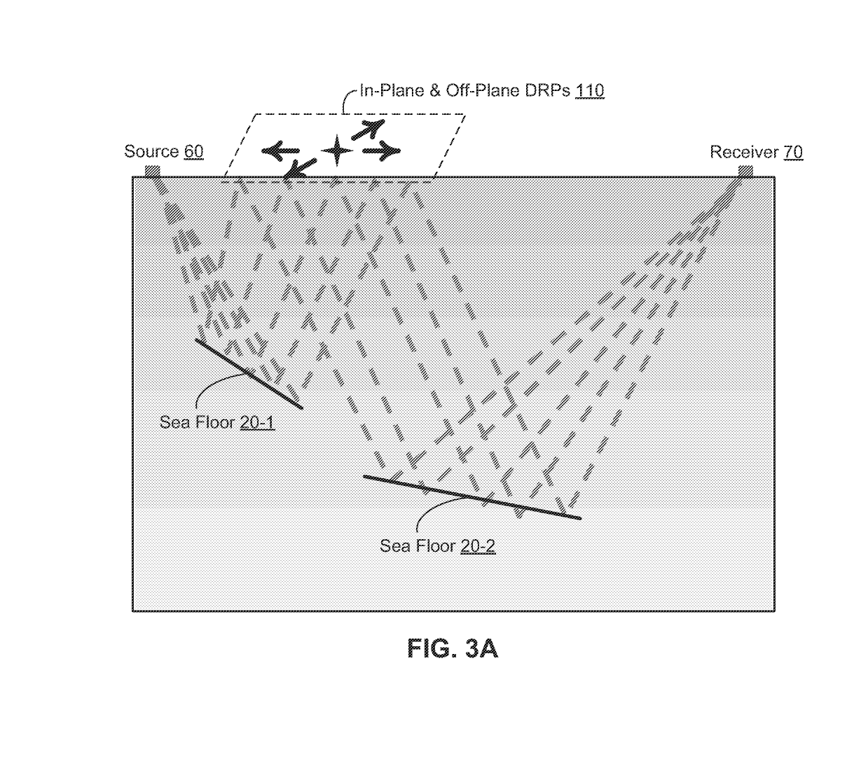

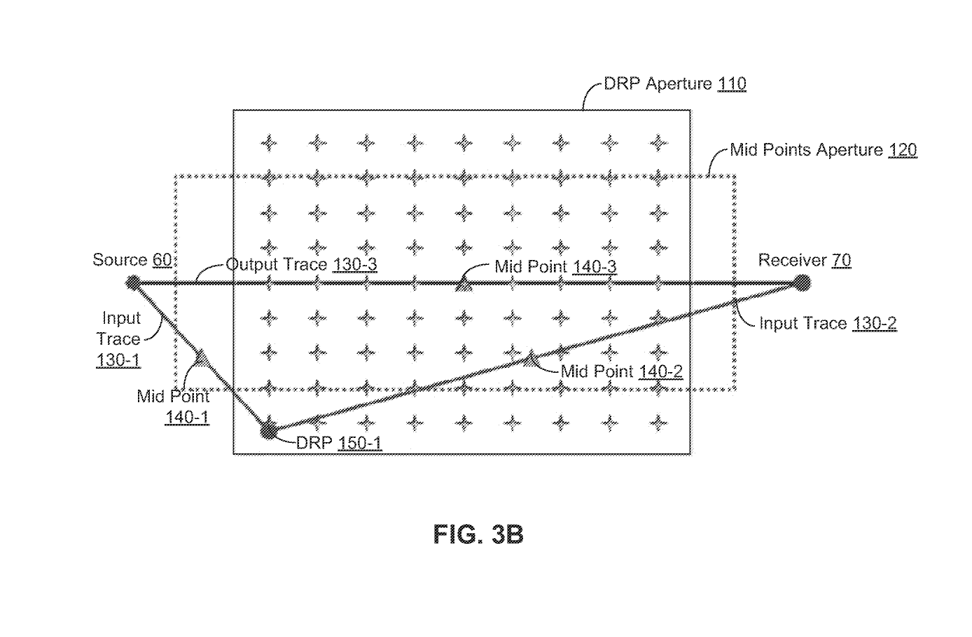

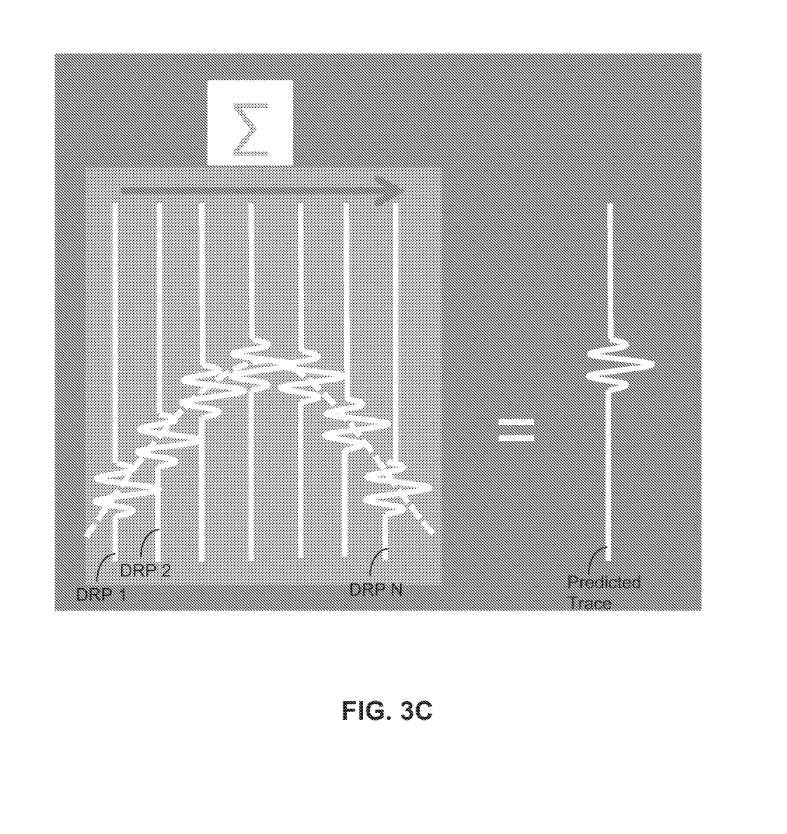

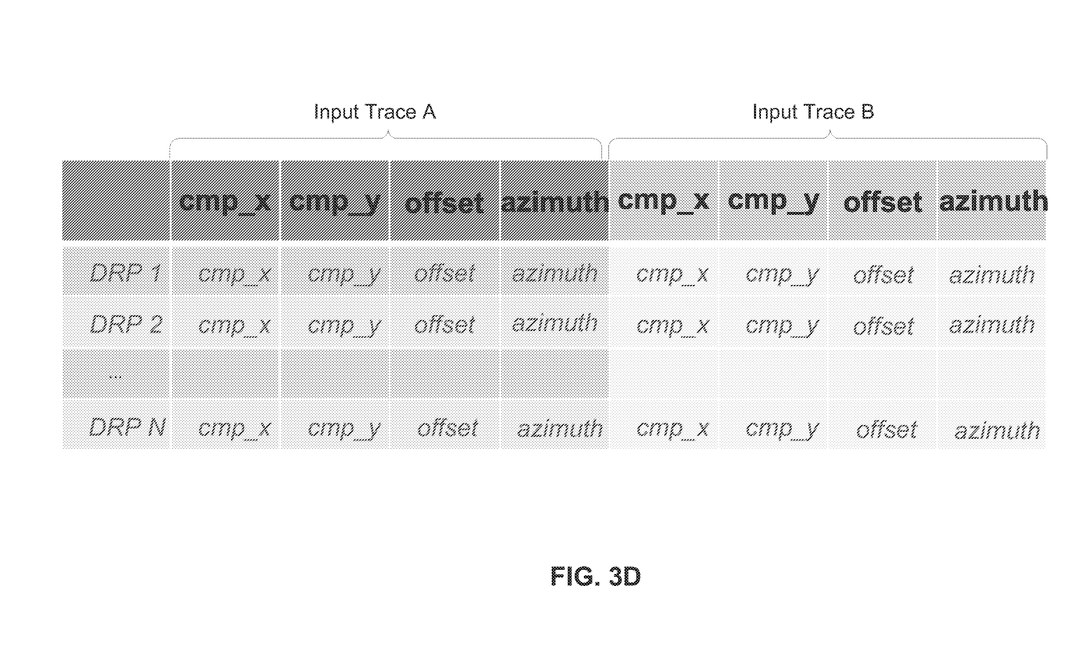

In reality, the sea floor is hardly a flat surface as shown in FIGS. 1 and 2A. Instead, as shown in FIG. 3A, there are often more than one propagation path of surface-related multiples between a source 60 and a receiver 70, which is especially the case in 3-D seismic data collection. For example, referring to FIG. 3A, the seismic wave departing from the source 60 may be first reflected by a portion of the sea floor 20-1 and then bounced back into the water by the in-plane and off-plane DRPs 110 at the sea surface. The seismic wave is then reflected by another portion of the sea floor 20 and finally captured by the receiver 70 as surface-related multiples. In order to predict the surface-related multiples between the source 60 and the receiver 70 more accurately, one approach is to sum together, i.e., stack, the convolution results described above in connection with FIGS. 2A and 2B for many possible propagation paths between the source 60 and the receiver 70 so that those actual surface-related multiples will be easier to detect since the convolution preserves the actual time delays of the surface-multiples between the source 60 and the receiver 70 while the stacking of the convolution results can effectively suppress the non-coherent noise in the seismic traces.

FIG. 3B depicts a top view of a plurality of DRPs located between the source 60 and the receiver 70, which are used for predicting surface-related multiples. The plurality of DRPs constitute a 2-D DRP aperture 110 on the sea surface. The process of predicting the surface-related multiple between the source 60 and the receiver 70 includes convolving a pair of seismic traces for each possible DRP in the DRP aperture 110. For example, a 3-D seismic dataset collected from the region including the DRP aperture 110 may include (i) a first seismic trace 130-1 generated at the DRP 150-1 (when there is a receiver at this location) whose mid-point 140-1 is between the source 60 and the DRP 150-1 and (ii) a second seismic trace 130-2 generated at the receiver 70 whose mid-point 140-2 is between the receiver 70 and the DRP 150-1 (when there is a source at this location). These two seismic traces can be convolved together to predict the surface-related multiples bounced off the sea surface at the DRP 150-1. The multiple prediction process repeats this step for every DRP in the DRP aperture 110 and then sums up the convolution results along a hyperbolic trajectory as shown in FIG. 3C into a predicted seismic trace, which includes a predicted version of the first-order surface-related multiples in the seismic trace 130-3 between the source 60 and the receiver 70 whose mid-point is 140-3.

Seismic data is typically collected in the format of shot profiles, each shot profile including multiple seismic traces captured by receivers at different locations in response to one dynamite or airgun exploration generated by the same source at a particular location. For convenience of subsequent data processing operations, these shot profiles are often re-organized into common-mid-point (CMP) gathers, each CMP gather including multiple seismic traces of having the same (or substantially the same) mid-point as shown in FIG. 3B. In other words, seismic traces within one CMP gather are captured by receivers at different locations in connection with different sources at different locations. As a result of this re-organization, seismic traces from the same shot profile will be distributed into different CMP gathers. In order to keep track of the relationship between a seismic trace and its associated pair of source and receiver, a trace header is generated for each seismic trace that records various metadata associated with this trace such as the coordinates of the source and the receiver as well as the mid-point, the shot profile number, and the CMP number, etc.

Referring again to FIG. 3B, the seismic trace 130-1 and the seismic trace 130-3 are likely belonging to the same shot profile because they both correspond to the same source 60. But, based on how seismic data is collected as described above, the seismic trace 130-2 is not likely part of the same shot profile as the other two seismic traces since it corresponds to the DRP 150-1 and the receiver 70. Moreover, all the seismic traces have different mid-points 140-1, 140-2, and 140-3. In other words, they are likely belonging to three different CMP gathers. On the other hand, the process of predicting the surface-related multiples requires the convolution of the two seismic traces 130-1 and 130-2 and the convolution result is subsequently used for eliminating the multiples from the seismic trace 130-3. This process is by no means trivial since, for each seismic trace to be processed, the multiple prediction process may need to identify more than one thousand pairs of seismic traces in the DRP aperture 110, one pair for each possible DRP and each trace within the pair coming from a different CMP gather, within a 3-D seismic dataset of hundreds of millions of seismic traces with a volume of a terabyte or more.

In some implementations, an important step of the process is to use the trace header information of the 3-D seismic dataset to generate a table like the one shown in FIG. 3D. Note that each row in the table represents the location information of two seismic traces to be convolved for a particular DRP. For 3-D seismic data, each input trace is identified by a set of coordinates (cmp_x, cmp_y, offset, azimuth). After the table is ready, the multiple prediction process is to loop through each row in the table, identify a pair of seismic traces for a particular DRP, retrieve the seismic data associated with the two seismic traces from a storage device, convolve the seismic data associated with the two seismic traces, and sum the convolution results from different DRPs together to generate a seismic trace including the predicted surface-related multiples between a pair of source and receiver. Below is a piece of pseudo-code illustrating this process:

for each output trace location (o_{src}, o_{rec}) {

prediction = zeros
determine a table of trace locations for the DRPs
for each row in the table (i.e., a possible DRP) {

select closest traces to (o_{src}, DRP)
select closest traces to (DRP, o_{rec})
interpolate trace1 from traces close to (o_{src}, DRP)
interpolate trace2 from traces close to (DRP, o_{rec})
prediction += trace1 * trace2

}
save prediction for this trace

}

Note that the pseudo-code includes two interpolation steps because a DRP might not exactly correspond to the location of a source or a receiver. In this case, a seismic trace associated with the DRP may have to be generated through interpolation of neighboring seismic traces.

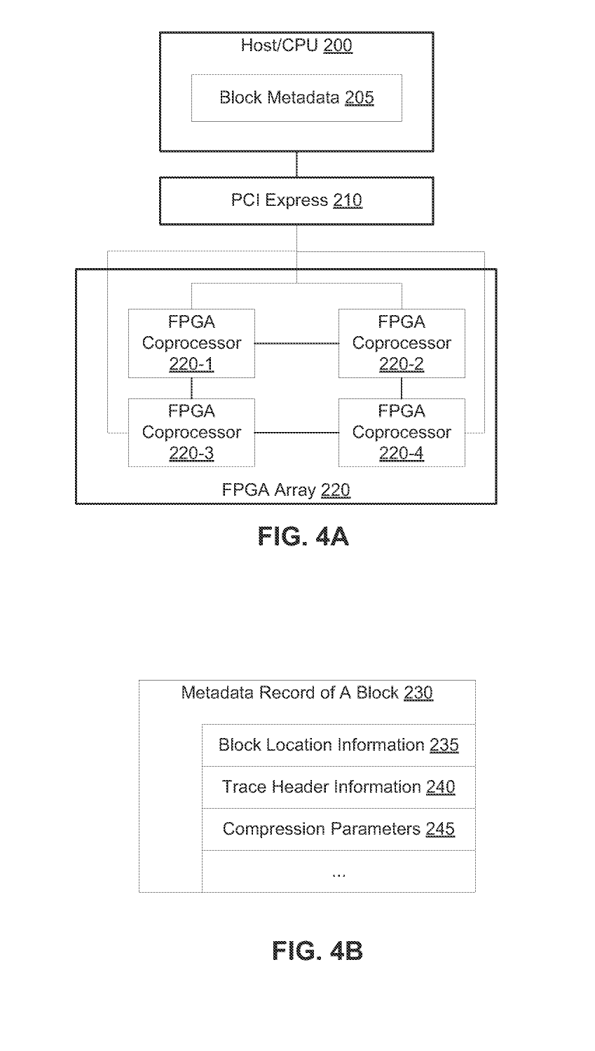

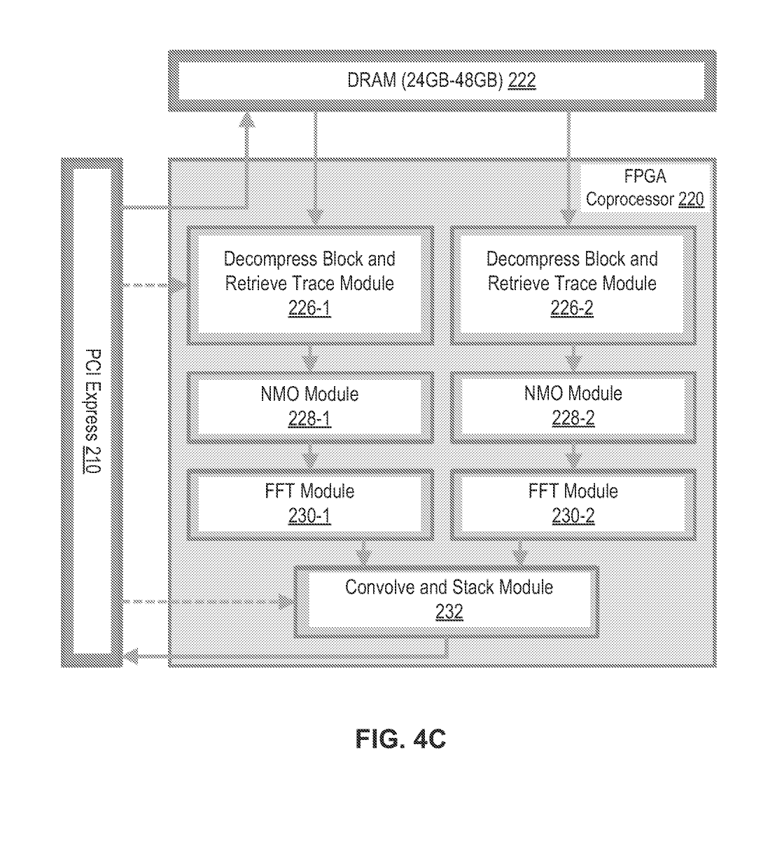

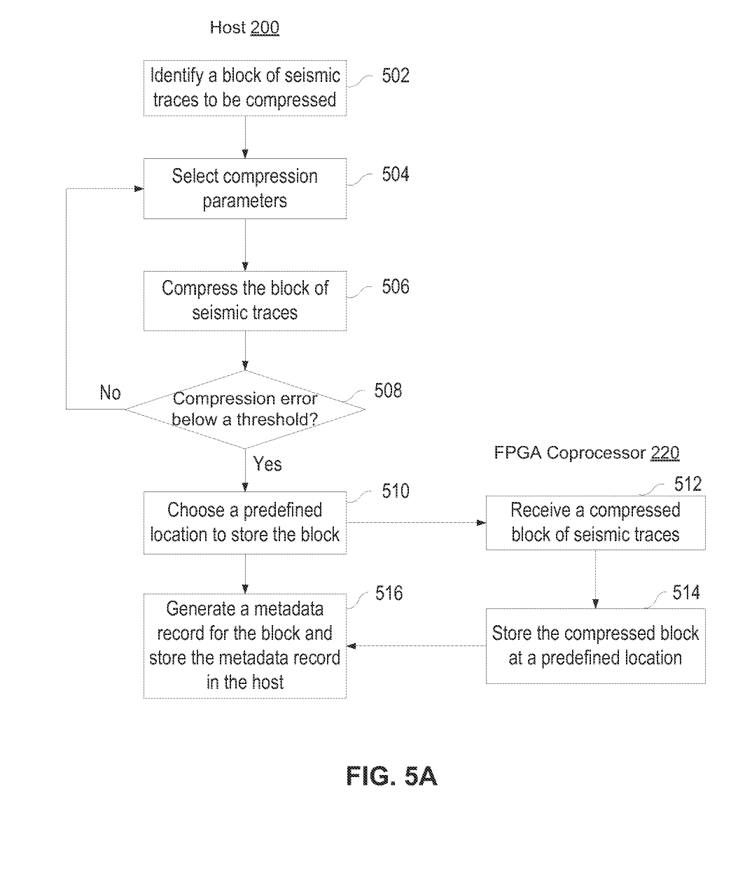

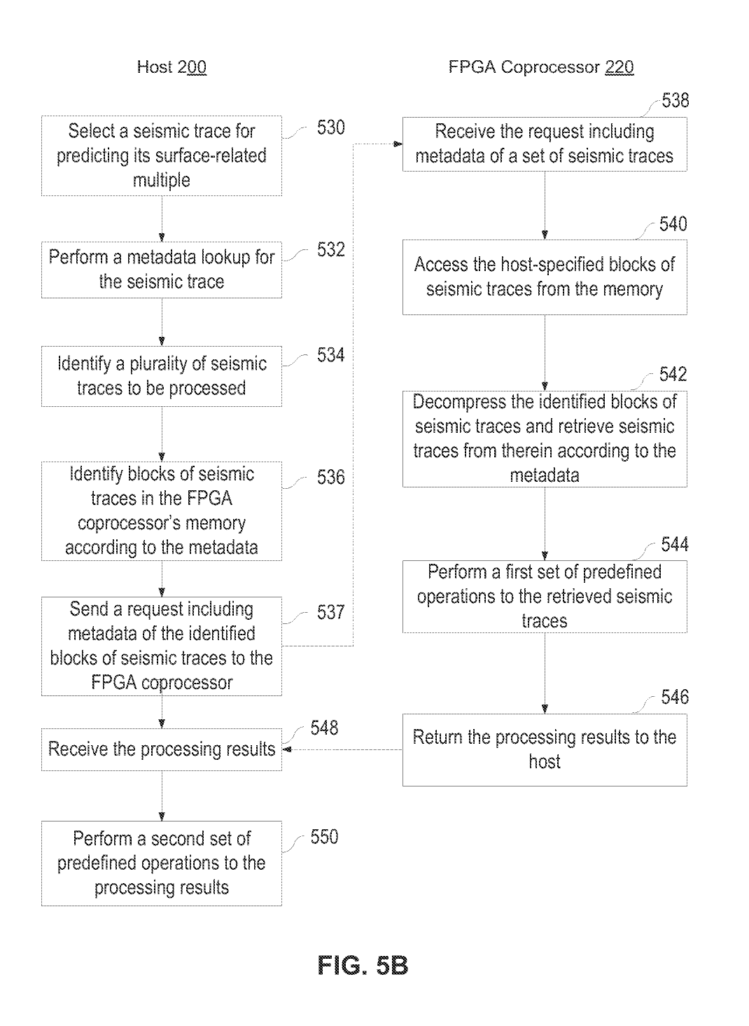

A challenge with implementing the surface-related multiples prediction process is the size of the 3-D seismic dataset (e.g., in the order of hundreds of gigabytes or even terabytes) is too large to fit into a computer system's memory. But given how seismic data is normally organized (e.g., in CMP gathers or shot profiles) and the random nature of two traces involved in a convolution operation, it is quite time-consuming to perform the surface-related multiples prediction process when the seismic data is stored in a large storage device such as a hard drive. But as noted above, people have developed FPGA coprocessors with 24 or even 48 gigabytes of memory for applications such as high-performance computing, and FPGAs are effective at performing data decompression which makes it possible to store a compressed 3-D seismic dataset entirely within the memory. For example, assuming a compression ratio of 50:1, an FPGA coprocessor having a 24-GB memory can host a 1200-GB seismic dataset before compression without appreciable loss of information. Thus, advantageously, an FPGA-based seismic data processing method is described below in connection with FIGS. 4 and 5. One exemplary implementation of the method is for predicting surface-related multiples.

FIG. 4A is a block diagram illustrating a computer architecture that includes a CPU-based host 200, an FPGA array 220, and a PCI Express 210 coupling the FPGA array 220 to the host 200. Given the uniqueness of CPU and FPGA, the process of predicting surface-related multiples for a 3-D seismic dataset is divided into two sub-processes:
(i) The host 200 is initially responsible for compressing the 3-D seismic dataset into a plurality of blocks (e.g., each block having a 16[=4×4] compressed seismic traces whose CMP-based coordinates cover a small 2-D area on the surface of the earth) and having the plurality of blocks stored in the memory of the FPGA array 220. During the multiple prediction process, the host 200 is responsible for generating a table of traces to be convolved like the one shown in FIG. 3D through the metadata 205 of the plurality of blocks managed by the host 200.
(ii) The FPGA coprocessors (220-1 to 220-4) in the FPGA array 220 are responsible for storing the plurality of blocks of compressed seismic traces in their memory, and in response to a request from the host 200, accessing and decompressing the respective blocks of compressed seismic traces and then convolving the decompressed seismic traces in accordance with the table generated by the host 200.

FIG. 4B is a block diagram illustrating a metadata record 230 for a particular block of compressed seismic traces. In this example, the metadata record 230 includes block location information 235 indicating where the block is stored in the memory of an FPGA coprocessor, trace header information 240 indicating the geometry information of the seismic traces in this block, and one or more compression parameters 245 indicating how the seismic traces in the block are compressed. Note that the block location information 235 is usually provided determined by the host 200 when it sends a block of compressed seismic traces to the FPGA coprocessor 220 for storage. The trace header information 240 is generated when the seismic dataset is collected and it usually includes the coordinates of the traces like the ones shown in FIG. 3D. Depending on specific data compression algorithm, the compression parameters 245 are often the parameters used for decompressing the same block of compressed seismic traces.

FIG. 4C is a block diagram illustrating the programmable logic of a particular FPGA coprocessor 220 used for predicting the surface-related multiples for a pair of source and receiver. The PCI Express 210 serves as a connection interface between the FPGA coprocessor 220 and the host 200 (not shown in FIG. 4C). The FPGA coprocessor 220 has access to a DRAM memory 222 of 24-48 GB. Within the FPGA coprocessor 220, there is:
one or more decompress block and retrieve trace modules (226-1, 226-2) for fetching blocks of compressed seismic traces from the memory 222, decompressing the blocks, and retrieving the seismic traces for convolution based on the information provided by the host 200;
one or more normal moveout (NMO) modules (228-1, 228-2) for applying normal moveout to the retrieved seismic traces;
one or more FFT modules (230-1, 230-2) for transforming the retrieved seismic traces from the time domain to the frequency domain; and
a convolve and stack module 232 for convolving the two seismic traces in the time domain (which corresponds to a multiplication operation in the frequency domain), stacking the convolution results together as the predicted surface-related multiples, and returning the predicted surface-related multiples to the host 200.

Note that the operations of predicting the surface-related multiples for a pair of source and receiver can be performed in parallel by different sets of modules within the FPGA coprocessor 220 until the stacking operation commences. Therefore, in some implementations, the convolve and stack module 232 shown in FIG. 4C may be decoupled into a convolve module and a stack module to maximize the parallel processing power of the FPGA coprocessor 220.

Finally, FIGS. 5A and 5B are flow charts illustrating how the host 200 interacts with the FPGA coprocessor 220 for performing one or more predefined operations (e.g., surface-related multiple prediction) to a 3-D seismic dataset stored in the memory of the FPGA coprocessor 220 in accordance with some implementations. In particular, FIG. 5A illustrates how the host 200 compresses the traces in the seismic dataset into blocks and has them stored in the memory of the FPGA coprocessor 220. Initially, the host 200 identifies (502) a block of traces of seismic data to be compressed. In some implementations, the seismic dataset is organized in the format of CMP gathers and the selection of seismic traces for a block may take into account of the traces' trace header information such that their mid-points are within a small predefined 2-D area on the surface of the earth. In some implementations, the seismic traces within the same block may have the same or similar offset and azimuth in order to achieve a higher compression ratio with little loss of information.

Next, the host 200 selects (504) the compression parameters and compresses (506) the block of seismic traces. Note that there are many well-known approaches of compressing seismic data (e.g., wavelet-based data compression) that can be used in the present application. A more detailed description of the wavelet-based data compression can be found in U.S. Pat. No. 5,745,392. An important consideration when compressing a seismic dataset is the loss of information due to the compression. In some implementations, the host 200 quantifies the compression error for each block and compares (508) the compression error with a predefined threshold. If the compression error is above the threshold (508-No), the host 200 may return to select a different set of compression parameters (e.g., reducing the compression ratio) and repeat the operations 506 and 508 until the block of compressed seismic traces satisfies the predefined threshold. The block of compressed seismic traces is then sent to the FPGA coprocessor 224 for storage. If the compression error is below the threshold (508-Yes), the host 200 then chooses (510) a predefined location for storing the blocks of seismic traces in the memory of the FPGA coprocessor 220.

After receiving (512) a block of compressed seismic traces, the FPGA coprocessor 220 stores (514) it at the host-specified predefined location within its memory. The host 200 generates (516) a metadata record for the block and stores the metadata in the host's memory. Note that the size of the metadata records associated with a 3-D seismic dataset is small enough to fit into the memory of the host 200.

As shown in FIG. 5B, the surface-related multiples prediction process begins with the host 200 selecting (530) a seismic trace associated with a pair of source and receiver for predicting its surface-related multiples. An important step of surface-related multiples prediction is to identify a pair of seismic traces for each DRP between the source and the receiver. In some implementations, the host 200 performs (532) a lookup over all the block metadata records associated with a 3-D seismic dataset and identifies (534) a plurality of seismic traces to be processed. For example, the host 200 needs to determine a block of compressed seismic traces for each of the plurality of seismic traces and a metadata record associated with the block. In some implementations, the host 200 identifies (536) one or more blocks of seismic traces in the FPGA coprocessor's memory according to their metadata and sends (537) a request including metadata of the identified blocks of seismic traces to the FPGA coprocessor 224, the request, e.g., including block location information and trace header information.

Upon receipt (538) of the request, the FPGA coprocessor 224 accesses (540) one or more of the host-specified blocks of compressed seismic traces in the memory in accordance with the block location information in the request. For example, for each pair of seismic traces, the FPGA coprocessor 224 identifies two blocks of compressed seismic traces if the two seismic traces are in two different blocks or one block of seismic traces if the two traces happen to be within the same block. Note that the efficiency of the process, to some extent, depends on the block size, i.e., the number of seismic traces within the block. If the block size is too large, it may take more time to decompress a block of compressed seismic traces and retrieve one of the decompressed traces. On the other hand, if the block size is too small, it should take less time to decompress a block but might be more difficult to achieve a higher compression ratio. In some implementations, the block size is set to be 4-32 traces depending on the nature of the seismic dataset. To reduce the amount of time for decompressing a block of seismic traces, the FPGA coprocessor 224 may employ a decompression algorithm such that it can retrieve a desired trace from the block without the entire block being fully decompressed.

After decompressing (542) the identified blocks and retrieving the seismic traces from therein according to the metadata in the request, the FPGA coprocessor 224 performs (544) a first set of predefined operations to the retrieved seismic traces. In some implementations, the predefined operations include applying a normal moveout to a decompressed trace of seismic data, performing a FFT to a decompressed trace of seismic data, convolving a respective pair of decompressed traces of seismic data when the trace information corresponding to the respective pair of decompressed traces satisfies a predefined condition, and stacking a plurality of decompressed traces of seismic data. For example, the convolution and the stack operations may be performed in the frequency domain while the other operations are performed in the time domain as described above in connection with FIG. 4B. In some other embodiments, at least one of the convolution and the stack operations may be performed in the time domain. Finally, the FPGA coprocessor 224 returns (546) the processing results (e.g., a seismic trace including a predicted version of surface-related multiples between a source and a receiver) to the host 200. Upon receipt (548) of the processing results, the host 200 may perform (550) a second set of predefined operations to the processing results. In some implementations, the predefined operations include performing an inverse FFT to the processing results and subtracting the predicted version of surface-related multiples from the seismic trace associated with the source-receiver pair.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. For example, it is possible to transform the seismic data from the time domain into the frequency domain and then have the data compression/decompression and multiple prediction/elimination operations performed in the frequency domain. Although the present application uses the surface-related multiple prediction as an example, it will be apparent to one of ordinary skill in the art that the subject matter may be practiced in other seismic data processing operations that may benefit from the organization of the compressed seismic traces in the FPGA coprocessor's memory without these specific details. In other instances, well-known methods, procedures, components, and circuits have not been described in detail so as not to unnecessarily obscure aspects of the embodiments.

Although the terms first, second, etc. may be used herein to describe various elements, these elements should not be limited by these terms. These terms are only used to distinguish one element from another. For example, first ranking criteria could be termed second ranking criteria, and, similarly, second ranking criteria could be termed first ranking criteria, without departing from the scope of the present invention. First ranking criteria and second ranking criteria are both ranking criteria, but they are not the same ranking criteria.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain principles of the invention and its practical applications, to thereby enable others skilled in the art to best utilize the invention and various implementations with various modifications as are suited to the particular use contemplated. Implementations include alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the implementations.

What is claimed is:

1. A seismic data processing method, comprising:
at a FPGA coprocessor having memory, wherein there are a plurality of blocks of compressed seismic traces in the memory:
receiving, from a host, a request for processing a predefined set of seismic traces, the request including block location information and trace header information;
accessing one or more of the plurality of blocks of compressed seismic traces in the memory in accordance with the block location information;
decompressing each of the one or more accessed blocks into one or more seismic traces thereby forming a plurality of decompressed traces of seismic data;
selecting all or a portion of the plurality of decompressed traces of seismic data in accordance with the trace header information;
processing the all or the portion of the plurality of decompressed traces of seismic data by applying one or more predefined operations to the seismic data; and
returning the processed seismic data to the host.

2. The method of claim 1, wherein the predefined set of seismic traces is used for predicting surface-related multiples within a seismic trace between a source and a receiver.

3. The method of claim 2, wherein the predefined set of seismic traces is collected within a region defined the source and the receiver.

4. The method of claim 2, wherein the host is configured to generate a seismic trace between the source and the receiver that is substantially free of surface-related multiples by subtracting the processed seismic data from the seismic trace between the source and the receiver.

5. The method of claim 1, wherein the one or more predefined operations include applying a normal moveout to a decompressed trace of seismic data, performing a FFT to a decompressed trace of seismic data, convolving a respective pair of decompressed traces of seismic data when the trace information corresponding to the respective pair of decompressed traces satisfies a predefined condition, and stacking a plurality of decompressed traces of seismic data.

6. The method of claim 5, wherein the predefined condition for convolving the respective pair of decompressed traces of seismic data is that the source or receiver locations of the two decompressed traces of seismic data correspond to one downward reflection point such that a convolution of the two decompressed traces of seismic data generates a prediction of surface-related multiples associated with the downward reflection point.

7. The method of claim 5, wherein the respective pair of decompressed traces of seismic data are retrieved from the same block of compressed seismic traces.

8. The method of claim 5, wherein the respective pair of decompressed traces of seismic data are retrieved from two distinct blocks of compressed seismic traces.

9. The method of claim 1, wherein different blocks of compressed seismic traces are decompressed using different sets of decompression parameters.

10. The method of claim 1, wherein the different sets of decompression parameters are included in the request from the host to the FPGA coprocessor.

11. The method of claim 1, wherein each block of compressed seismic traces includes a plurality of traces of seismic data whose associated mid-point coordinates are within a predefined 2-D area on the surface of the earth.

12. A seismic data processing method, comprising:
determining, at a host, location information of a plurality of pairs of seismic traces for a target seismic trace, wherein the plurality of pairs of seismic traces are used for predicting coherent noise in the target seismic trace;
sending the location information of the plurality of pairs of seismic traces from the host to a FPGA coprocessor, wherein there are a plurality of blocks of compressed seismic traces in a memory of the FPGA coprocessor;
accessing, at the FPGA coprocessor, blocks of compressed seismic traces in the plurality of blocks in the memory in accordance with the location information of the plurality of pairs of seismic traces;
decompressing, at the FPGA coprocessor, the accessed blocks of compressed seismic traces and retrieving the plurality of pairs of seismic traces from the decompressed blocks of seismic traces;
applying, at the FPGA coprocessor, one or more predefined operations to the retrieved plurality of pairs of seismic traces to generate an estimate of the coherent noise in the target seismic trace;
returning the estimate of the coherent noise from the FPGA coprocessor to the host; and
subtracting the estimate of the coherent noise from the target seismic trace.

13. The method of claim 12, wherein the coherent noise is surface-related multiples.

14. The method of claim 12, wherein the location information of each pair of seismic traces identifies respective locations of two source-receiver pairs associated with the two seismic traces and the respective locations of the two source-receiver pairs correspond to three locations on the surface of the earth including respective locations of a source-receiver pair associated with the target seismic trace and a location of a downward reflection point between the source-receiver pair.

15. The method of claim 12, wherein the one or more predefined operations include applying a normal moveout to a decompressed trace of seismic data, performing a FFT to a decompressed trace of seismic data, convolving a respective pair of decompressed traces of seismic data when the trace information corresponding to the respective pair of decompressed traces satisfies a predefined condition, and stacking a plurality of decompressed traces of seismic data.

16. The method of claim 15, wherein the predefined condition for convolving the respective pair of decompressed traces of seismic data is that the source or receiver locations of the two decompressed traces of seismic data correspond to one downward reflection point such that a convolution of the two decompressed traces of seismic data generates a prediction of surface-related multiples associated with the downward reflection point.

17. The method of claim 15, wherein the respective pair of decompressed traces of seismic data are retrieved from the same block of compressed seismic traces.

18. A FPGA coprocessor configured for seismic data processing, comprising:
memory, wherein there are a plurality of blocks of compressed seismic traces in the memory; and
seismic data processing programmable logic, wherein the seismic data processing programmable logic is configured to:
receive, from a host, a request for processing a predefined set of seismic traces, the request including block location information and trace header information;
access one or more of the plurality of blocks of compressed seismic traces in the memory in accordance with the block location information;
decompress each of the one or more accessed blocks into one or more seismic traces thereby forming a plurality of decompressed traces of seismic data;
selecting all or a portion of the plurality of decompressed traces of seismic data in accordance with the trace header information;
process the all or the portion of the plurality of decompressed traces of seismic data by applying one or more predefined operations to the seismic data; and
returning the processed seismic data to the host.

19. The FPGA coprocessor of claim 18, wherein the predefined set of seismic traces is used for predicting surface-related multiples within a seismic trace between a source and a receiver.

20. The FPGA coprocessor of claim 18, wherein the one or more predefined operations include applying a normal moveout to a decompressed trace of seismic data, performing a FFT to a decompressed trace of seismic data, convolving a respective pair of decompressed traces of seismic data when the trace information corresponding to the respective pair of decompressed traces satisfies a predefined condition, and stacking a plurality of decompressed traces of seismic data.
